(19) United States
(12) Patent Application Publication
(10) Pub. No.: US 2016/0337626 A1
(43) Pub. Date: Nov. 17, 2016

(54) PROJECTION APPARATUS

(71) Applicant: Panasonic Intellectual Property Management Co., Ltd., Osaka (JP)

(72) Inventor: Kunihiro MIMA, Kyoto (JP)

(21) Appl. No.: 15/220,702

(22) Filed: Jul. 27, 2016

Related U.S. Application Data
(63) Continuation of application No. PCT/JP2015/005135, filed on Oct. 9, 2015.

(30) Foreign Application Priority Data
Dec. 25, 2014 (JP) 2014-263638

(51) Int. Cl. H04N 9/31

(52) U.S. Cl. CPC H04N 9/3185; H04N 9/3194

(57) ABSTRACT

The projection apparatus according to the present disclosure includes a projection unit, a detector, and a controller. The projection unit projects a projection image. The detector detects a state of an obstruction in projecting a projection image within a predetermined first projection region. The controller sets a region where a projection image is projected first to the first projection region. The controller changes the region where the projection image is projected from the first projection region to a predetermined second projection region different from the first projection region, when the state of the obstruction detected by the detector corresponds to a predetermined condition.

### BACKGROUND

1. Technical Field

The present disclosure relates to a projection apparatus that projects an image.

2. Description of the Related Art

Unexamined Japanese Patent Publication No. 2004-48695 discloses a projection-type image display system that can change a projection position of an image. The projection-type image display system disclosed in Patent Literature 1 includes a sensor that performs sensing to a projection target region where an image is to be projected, and detection means that executes an edge detection process or a color distribution detection process based on the sensing information to output detection information. The projection-type image display system determines a projectable region which has no obstructions within the target projection region based on the detection information, and adjusts a projection size of an image to be projected in such a manner that the image is projected on the projectable region. With this, in a case where an obstruction is present within the projection target region on which an image is to be projected, the image is projected with the projection size being reduced so as to avoid the obstruction within the projection target region.

### SUMMARY

The present disclosure provides a projection apparatus that enables an object, which is a person or the like, to easily see a projection image without being affected by an obstruction, when the projection image is projected for presentation to the object.

The projection apparatus according to the present disclosure includes a projection unit, a detector, and a controller. The projection unit projects a projection image. The detector detects a state of an obstruction in projecting a projection image within a predetermined first projection region. The controller sets a region where a projection image is projected first to the first projection region. The controller changes the region where the projection image is projected from the first projection region to a predetermined second projection region different from the first projection region, when the state of the obstruction detected by the detector corresponds to a predetermined condition.

The projection apparatus according to the present disclosure changes the projection region to the second projection region from the first projection region, when the state of the obstruction corresponds to the predetermined condition with the projection image being projected on the first projection region. This enables an object, which is a person or the like, to easily see the projection image without being affected by the obstruction, when the projection image is projected for presentation to the object.

### BRIEF DESCRIPTION OF DRAWINGS

FIG. 1 is a conceptual diagram in which a projector apparatus projects a video image onto a wall;

FIG. 2 is a conceptual diagram in which a projector apparatus projects a video image onto a floor;

FIG. 3 is a block diagram illustrating the electric configuration of the projector apparatus;

FIG. 4A is a block diagram illustrating the electric configuration of a distance detector;

FIG. 4B is a diagram for describing an infrared image captured by the distance detector;

FIG. 5 is a block diagram illustrating the optical configuration of the projector apparatus;

FIG. 6A is an explanatory view for describing an outline of the operation of the projector apparatus;

FIG. 6B is an explanatory view for describing an outline of the operation of the projector apparatus;

FIG. 6C is an explanatory view for describing an outline of the operation of the projector apparatus;

FIG. 7 is a flowchart for describing a changing projection process with the projector apparatus;

FIG. 8A is an explanatory view for describing a method for detecting a person with the projector apparatus;

FIG. 8B is an explanatory view for describing a method for detecting a person with the projector apparatus;

FIG. 8C is an explanatory view for describing a method for detecting a person with the projector apparatus;

FIG. 9 is an explanatory view for describing a method for detecting a crowd with the projector apparatus;

FIG. 10A is an explanatory view for describing a projection position of a projection image with the projector apparatus; and

FIG. 10B is an explanatory view for describing a projection position of a projection image with the projector apparatus.

### DETAILED DESCRIPTION OF THE PREFERRED EMBODIMENTS

Exemplary embodiments will be described below in detail with reference to the drawings as necessary. However, more than necessary detailed descriptions will sometimes be omitted. For example, detailed descriptions for matters which have already been well known in the art and redundant descriptions for substantially the same configurations will sometimes be omitted. This is to prevent the description below from becoming unnecessarily redundant to facilitate understanding of a person skilled in the art.

Note that the accompanying drawings and the following description are provided by the applicant in order for a person of ordinary skill in the art to sufficiently understand the present disclosure, and they are not intended to limit the subject matter set forth in the claims.

### First Exemplary Embodiment

Projector apparatus 100 will be described as a specific exemplary embodiment of a projection apparatus according to the present disclosure.

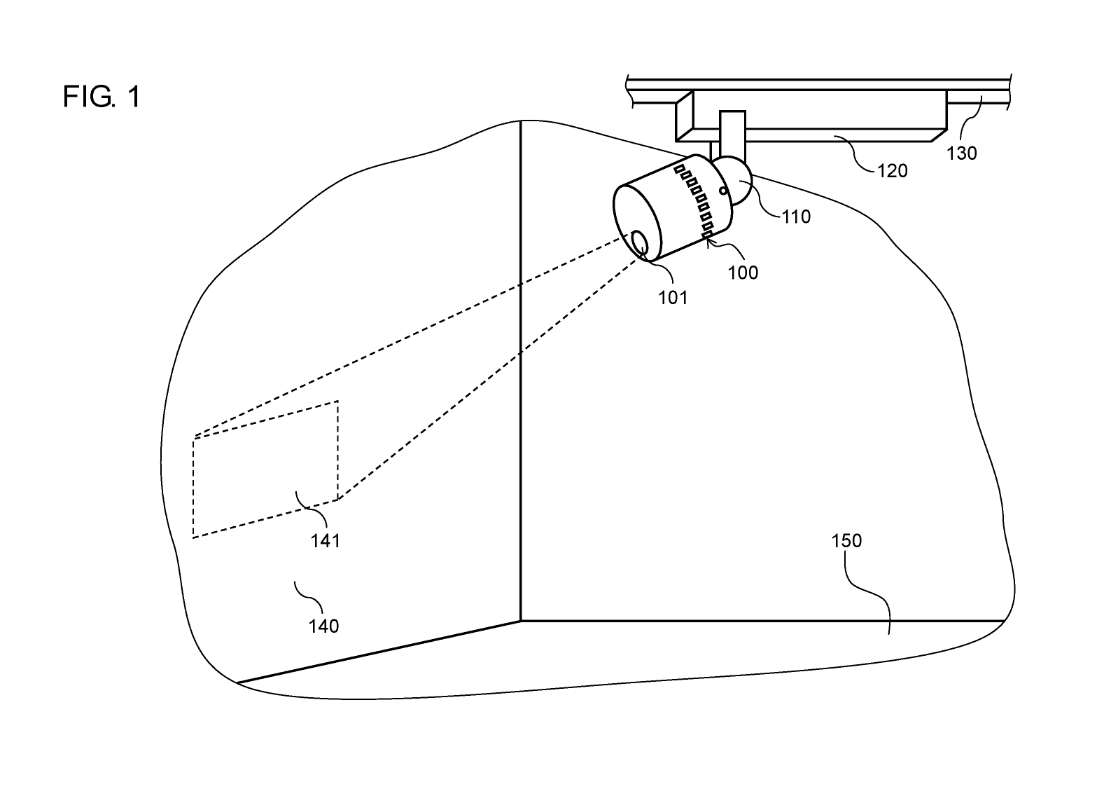

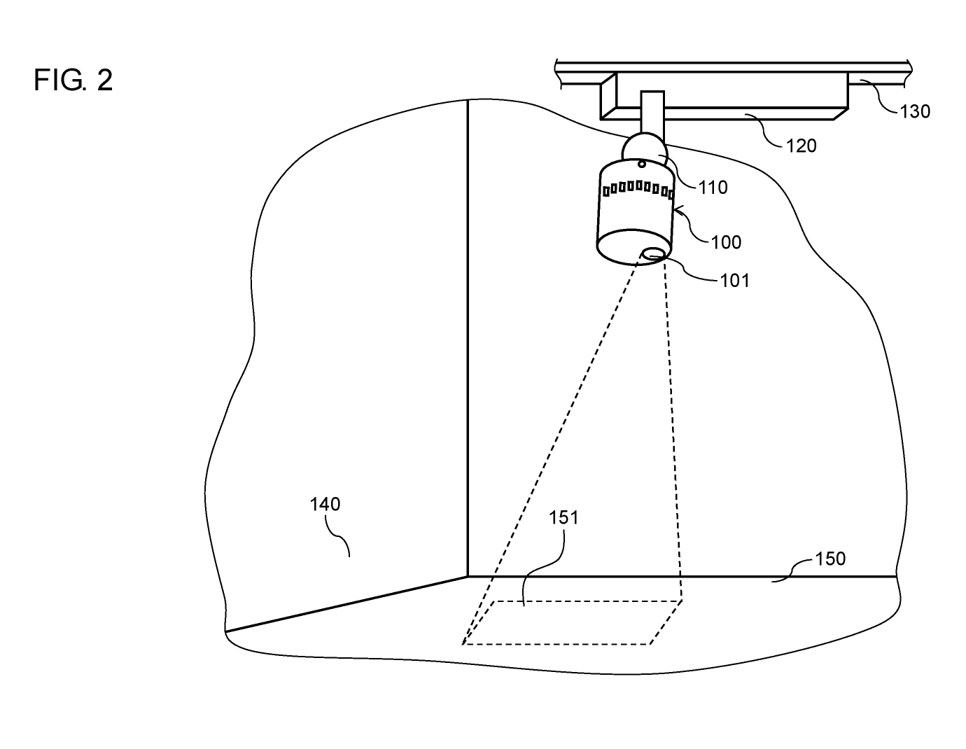

The outline of an image projecting operation with projector apparatus 100 will be described with reference to FIGS. 1 and 2. FIG. 1 is a conceptual diagram in which projector apparatus 100 projects a video image onto wall 140. FIG. 2 is a conceptual diagram in which projector apparatus 100 projects a video image onto floor 150.

As illustrated in FIGS. 1 and 2, projector apparatus 100 is fixed to housing 120 with drive unit 110. Wiring lines electrically connected to components configuring projector apparatus 100 and drive unit 110 are connected to a power source through housing 120 and wiring duct 130. With this, power is supplied to projector apparatus 100 and drive unit 110. Projector apparatus 100 has opening 101. Projector apparatus 100 projects a video image through opening 101.

Drive unit 110 can drive projector apparatus 100 so as to change a projection direction of projector apparatus 100. Drive unit 110 can drive a body of projector apparatus 100 in a pan direction (horizontal direction) and a tilt direction (vertical direction). As illustrated in FIG. 1, drive unit 110 can drive projector apparatus 100 so that the projection direction of projector apparatus 100 is toward wall 140. Thus, projector apparatus 100 can project video image 141 onto wall 140. Similarly, drive unit 110 can drive projector apparatus 100 so that the projection direction of projector apparatus 100 is toward floor 150 as illustrated in FIG. 2. Thus, projector apparatus 100 can project video image 151 onto floor 150. Drive unit 110 may be driven based on a manual operation of a user, or may automatically be driven in response to a detection result of a predetermined sensor. Further, video image 141 projected on wall 140 and video image 151 projected on floor 150 may be different from each other or may be the same.

Projector apparatus 100 includes user interface device 200. Thus, projector apparatus 100 can execute various controls to a projection image according to an operation of a person or a standing position of a person.

The configuration and operation of projector apparatus 100 will be described below in detail.

<1. Configuration of Projector Apparatus>

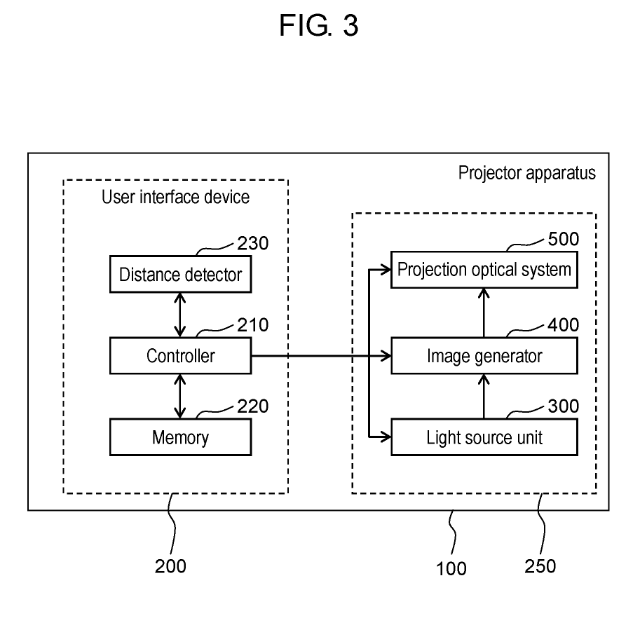

FIG. 3 is a block diagram illustrating the electric configuration of projector apparatus 100. Projector apparatus 100 includes user interface device 200 and projection unit 250. Projection unit 250 includes light source unit 300, image generator 400, and projection optical system 500. The configuration of the components configuring projector apparatus 100 will sequentially be described below.

User interface device 200 includes controller 210, memory 220, and distance detector 230. Distance detector 230 is one example of a first detector that detects a state of an obstruction in projecting a projection image within a predetermined first projection region, and also one example of a second detector that detects a specific object.

Controller 210 is a semiconductor element that entirely controls projector apparatus 100. Specifically, controller 210 controls the components (distance detector 230, memory 220) configuring user interface device 200, light source unit 300, image generator 400, and projection optical system 500. Controller 210 can also perform a digital zoom control for zooming out and zooming in a projection image with a video image signal process. Controller 210 may be formed only by hardware, or may be implemented by combining hardware and software.

Memory 220 is a memory element that stores various information. Memory 220 is configured by a flash memory or ferroelectric memory. Memory 220 stores a control program and the like for controlling projector apparatus 100. Memory 220 also stores various information supplied from controller 210. Memory 220 also stores setting of a projection size with which a projection image is expected to be displayed, and data such as a table of focusing values according to distance information to a projection target.

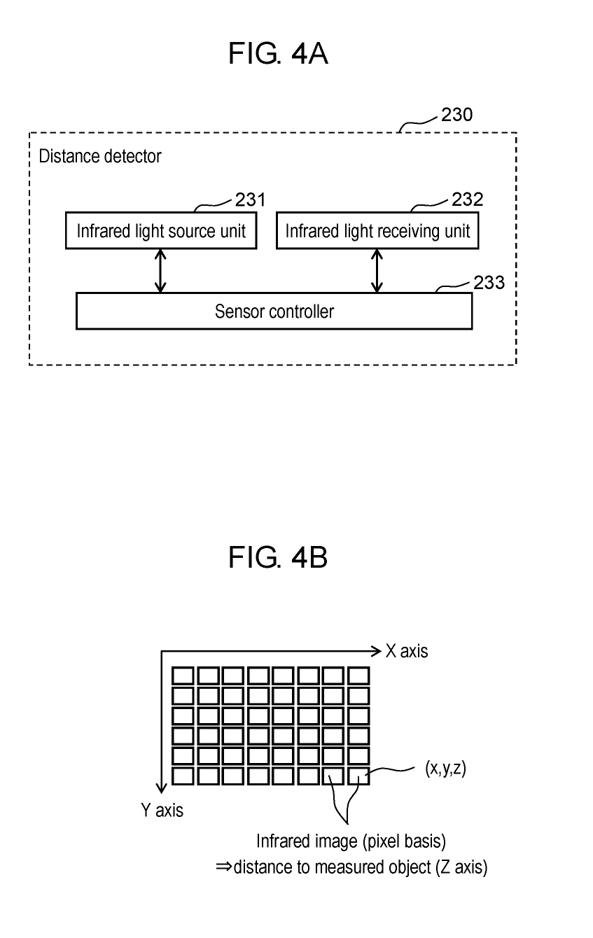

Distance detector 230 is configured by a TOF (Time-of-Flight) sensor, for example, and linearly detects the distance to an opposed surface. When facing wall 140, distance detector 230 detects the distance to wall 140 from distance detector 230. Similarly, when facing floor 150, distance detector 230 detects the distance to floor 150 from distance detector 230. FIG. 4A is a block diagram illustrating the electric configuration of distance detector 230. As illustrated in FIG. 4A, distance detector 230 includes infrared light source unit 231 that emits infrared detection light, infrared light receiving unit 232 that receives infrared detection light reflected on an opposed surface, and sensor controller 233. Infrared light source unit 231 emits infrared detection light through opening 101 such that the infrared detection light is diffused all around. Infrared light source unit 231 uses infrared light having a wavelength of 850 nm to 950 nm as infrared detection light, for example. Sensor controller 233 stores the phase of the infrared detection light emitted from infrared light source unit 231 in an internal memory of sensor controller 233. In a case where the opposed surface is not equally distant from distance detector 230 and has a tilt or shape, a plurality of pixels arrayed on an imaging surface of infrared light receiving unit 232 receives reflection light at different timings. Since the plurality of pixels receives light at different timings, the infrared detection light received by infrared light receiving unit 232 has different phases for each pixel. Sensor controller 233 stores the phase of the infrared detection light received by each pixel of infrared light receiving unit 232 in the internal memory.

Sensor controller 233 reads the phase of the infrared detection light emitted from infrared light source unit 231 and the phase of the infrared detection light received by each pixel in infrared light receiving unit 232 from the internal memory. Sensor controller 233 measures the distance to the opposed surface from distance detector 230 based on the phase difference between the infrared detection light emitted from distance detector 230 and the received infrared detection light, thereby generating distance information (distance image).

FIG. 4B is a diagram for describing distance information acquired by infrared light receiving unit 232 in distance detector 230. Distance detector 230 detects a distance for each of the pixels configuring an infrared image with the received infrared detection light. With this, controller 210 can acquire the detection result of the distance of the infrared image received by distance detector 230 in the entire angle of view on a pixel basis. In the description below, an X axis is defined in the horizontal direction of the infrared image, and a Y axis is defined in the vertical direction, as illustrated in FIG. 4B. A Z axis is defined in the direction of the detected distance. Controller 210 can acquire coordinates (x, y, z) of three axes of XYZ for each pixel configuring the infrared image based on the detection result of distance detector 230. Specifically, controller 210 can acquire distance information (distance image) based on the detection result of distance detector 230. Controller 210 acquires distance information every predetermined time interval (e.g., 1/60 second).

A TOF sensor is used as distance detector 230 in the above. However, the present disclosure is not limited thereto. Specifically, distance detector 230 may use the one that projects a known pattern such as a random dot pattern and calculates distance using the deviation from the pattern, or may be the one that uses a parallax with a stereo camera.

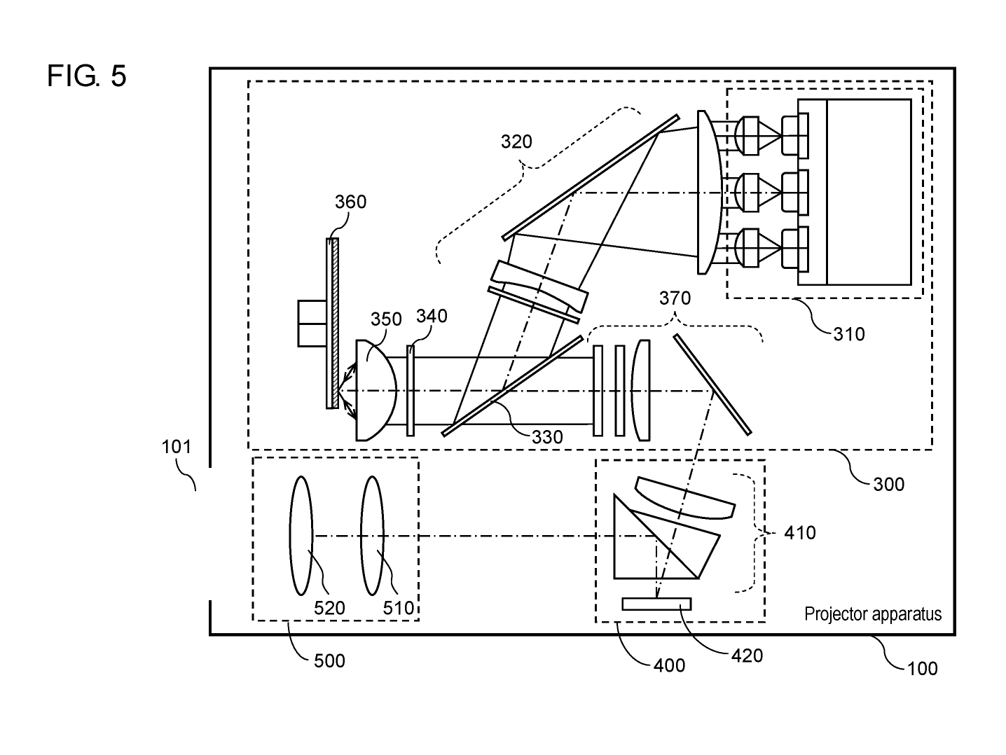

Next, the configuration of light source unit 300, image generator 400, and projection optical system 500, which are the components other than user interface device 200 out of the components mounted to projector apparatus 100, will be described with reference to FIG. 5. FIG. 5 is a block diagram illustrating the optical configuration of projector apparatus 100. As illustrated in FIG. 5, light source unit 300 supplies light, which is necessary for generating a projection image, to image generator 400. Image generator 400 supplies the generated video image to projection optical system 500. Projection optical system 500 performs optical conversion, such as focusing and zooming, to the video image supplied from image generator 400. Projection optical system 500 faces opening 101, and a video image is projected through opening 101.

The configuration of light source unit 300 will firstly be described. As illustrated in FIG. 5, light source unit 300 includes semiconductor laser 310, dichroic mirror 330, λ/4 plate 340, phosphor wheel 360, and the like.

Semiconductor laser 310 is a solid light source that emits S-polarized blue light having a wavelength of 440 nm to 455 nm, for example. S polarized blue light emitted from semiconductor laser 310 is incident on dichroic mirror 330 through light guide optical system 320.

For example, dichroic mirror 330 is an optical element having a high reflectance of 98% or more for S polarized blue light having a wavelength of 440 nm to 455 nm and having a high transmittance of 95% or more for P polarized blue light having a wavelength of 440 nm to 455 nm and green light to red light having a wavelength of 490 nm to 700 nm regardless of the polarization state. Dichroic mirror 330 reflects S polarized blue light emitted from semiconductor laser 310 toward λ/4 plate 340.

λ/4 plate 340 is a polarization element that converts linear polarized light into circular polarized light or converts circular polarized light into linear polarized light. λ/4 plate 340 is disposed between dichroic mirror 330 and phosphor wheel 360. S polarized blue light incident on λ/4 plate 340 is converted into circular polarized blue light, and then, emitted to phosphor wheel 360 through lens 350.

Phosphor wheel 360 is an aluminum flat plate configured to be rotatable at a high speed. Phosphor wheel 360 has, on its surface, a plurality of B regions that is a region of a diffusion reflection plane, a plurality of G regions on which a phosphor emitting green light is applied, and a plurality of R regions on which a phosphor emitting red light is applied. Circular polarized blue light emitted to the B regions on phosphor wheel 360 is diffusely reflected, and again enters λ/4 plate 340 as circular polarized blue light. Circular polarized blue light incident on λ/4 plate 340 is converted into P polarized blue light, and then, again enters dichroic mirror 330. The blue light incident on dichroic mirror 330 at that time is P polarized light. Therefore, this blue light passes through dichroic mirror 330, and enters image generator 400 through light guide optical system 370.

Blue light emitted on the G regions or the R regions on phosphor wheel 360 excites the phosphor applied on the G regions or the R regions to allow the phosphor to emit green light or red light. Green light or red light emitted from the G regions or the R regions enters dichroic mirror 330. The green light or red light incident on dichroic mirror 330 at that time passes through dichroic mirror 330, and enters image generator 400 through light guide optical system 370.

Due to the high-speed rotation of phosphor wheel 360, blue light, green light, and red light are time divided and emitted from light source unit 300 to image generator 400.

Image generator 400 generates a projection image according to a video image signal supplied from controller 210. Image generator 400 includes DMD (Digital-Mirror-Device) 420, and the like. DMD 420 is a display element on which a lot of micromirrors are arrayed on a flat plane. DMD 420 deflects each of the arrayed micromirrors according to the video image signal supplied from controller 210 to spatially modulate incident light. Light source unit 300 emits blue light, green light, and red light in a time-division way. DMD 420 repeatedly and sequentially receives blue light, green light, and red light which are time divided and emitted through light guide optical system 410. DMD 420 deflects each of the micromirrors in synchronization with the timing at which light of each color is emitted. With this, image generator 400 generates a projection image according to the video image signal. DMD 420 deflects the micromirrors to form light directed to projection optical system 500 and to form light directed outside an effective range of projection optical system 500, according to the video image signal. With this, image generator 400 can supply the generated projection image to projection optical system 500.

Projection optical system 500 includes optical members such as zoom lens 510 and focusing lens 520. Projection optical system 500 enlarges light directed from image generator 400 and projects the resultant light on a projection plane. Controller 210 adjusts the position of zoom lens 510, thereby being capable of controlling a projection region relative to a projection target in order to attain a desired zoom value. Controller 210 can enlarge a projection image which is to be projected onto a projection plane by increasing a zoom magnification. In this case, controller 210 moves zoom lens 510 in the direction in which an angle of view is widened (toward wide end) to expand the projection region. On the other hand, controller 210 can make a projection image which is to be projected onto a projection plane small by decreasing a zoom magnification. In this case, controller 210 moves zoom lens 510 in the direction in which an angle of view is narrowed (toward tele end) to narrow the projection region. In addition, controller 210 adjusts the position of focusing lens 520 based on predetermined zoom tracking data so as to track the movement of zoom lens 510, thereby being capable of performing focusing of a projection image.

In the above description, the configuration of DLP (Digital-Light-Processing) system using DMD 420 is used as one example of projector apparatus 100. However, the present disclosure is not limited thereto. That is, a configuration of a liquid crystal type may be used as projector apparatus 100.

The configuration of a single-plate type in which a light source using phosphor wheel 360 is time divided has been described above as one example of projector apparatus 100. However, the present disclosure is not limited thereto. That is, the configuration of a three-plate type including light sources of blue light, green light, and red light may be used for projector apparatus 100.

The configuration in which the light source of blue light for generating a projection image and a light source of infrared light for measuring distance are different units has been described above. However, the present disclosure is not limited thereto. That is, a unit formed by combining a light source of blue light for generating a projection image and a light source of infrared light for measuring distance may be used. If the three-plate type is employed, a unit formed by combining light sources of respective colors and a light source of infrared light may be used.

<2. Operation>

2-1. Outline of Operation

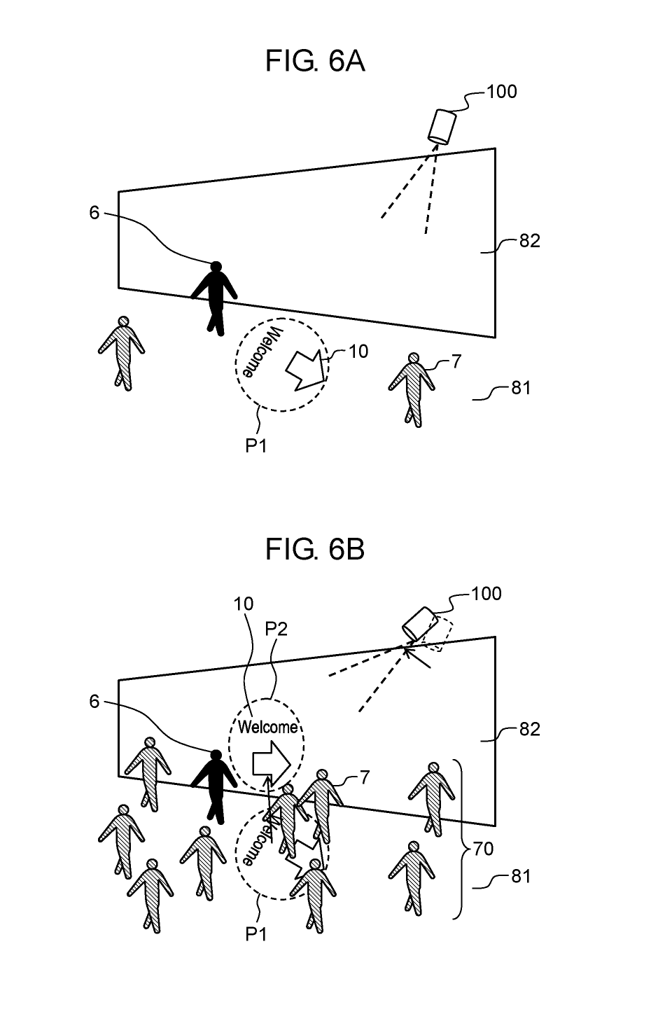

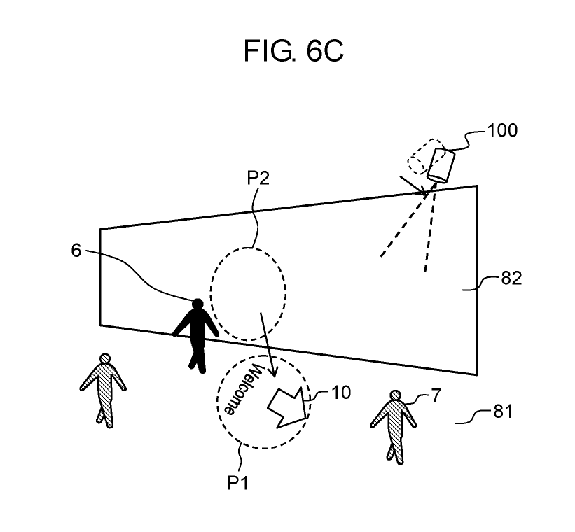

The outline of a projecting operation of projector apparatus 100 according to the present exemplary embodiment will be described with reference to FIGS. 6A, 6B, and 6C. FIGS. 6A, 6B, and 6C are explanatory views for describing the outline of the operation of projector apparatus 100 according to the present exemplary embodiment. FIG. 6A illustrates the operation for projecting a projection image onto a projection position on a floor surface. FIG. 6B illustrates the operation of changing the projection position to a wall surface from the floor surface according to a crowd. FIG. 6C illustrates the operation of returning the projection position to the floor surface from the wall surface according to clearing of the crowd.

Projector apparatus 100 according to the present exemplary embodiment detects a specific person using distance information from distance detector 230, and projects a predetermined projection image near the person by tracking the movement of the detected person. As illustrated in FIGS. 6A to 6C, projector apparatus 100 is installed on a corridor or passage on which several persons pass, and projects projection image 10 while tracking person 6. For example, projection image 10 includes an arrow for guiding person 6, a welcome message for person 6, an advertising text, and an image for creating an impressive presentation for a movement of person 6, such as a red carpet. Projection image 10 may be a still image or a moving image. In this case, floor surface 81 is considered to easily come into the field of vision of person 6 who is now walking or moving, and thus, to be likely to attract attention of person 6. In view of this, in the present exemplary embodiment, projection image 10 is basically projected on projection position P1 on floor surface 81 as illustrated in FIG. 6A.

However, there may be a case where a region required to project projection image 10 cannot be ensured on floor surface 81, since floor surface 81 is crowded with many persons and the projection is obstructed. Therefore, in the present exemplary embodiment, the state of obstructions 7 other than person 6 on floor surface 81 is detected as illustrated in FIG. 6B. In this case, the obstruction means an object (person or object) that blocks the projection image from reaching the floor surface when projector apparatus 100 projects the image on the projection plane such as floor surface 81. In a case where the projection of the projection image is highly likely to be blocked such as a case where there is crowd 70 on floor surface 81, projector apparatus 100 exceptionally changes to project projection image 10 to wall surface 82 from floor surface 81. Projector apparatus 100 projects projection image 10 on projection position P2 on wall surface 82 with a height by which person 6 tracked by projector apparatus 100 is easy to see projection image 10. Thus, projection image 10 can attract attention of person 6 even in crowd 70.

The condition of crowd 70 is changing from time to time. Therefore, crowd 70 may be cleared after projection image 10 cannot be projected on floor surface 81 due to crowd 70 that becomes an obstruction, and so, projection of projection image 10 on floor surface 81 may be again enabled. In such a case, projector apparatus 100 returns the projection region where projection image 10 is to be projected to floor surface 81 which is easily seen by person 6. For this, the condition of crowd 70 on floor surface 81 is monitored even during the period of projecting projection image 10 onto wall surface 82 in the present exemplary embodiment. Then, when crowd 70 is cleared away from projection position P1 on floor surface 81, projector apparatus 100 returns the region where projection image 10 is to be projected to floor surface 81 from wall surface 82 as illustrated in FIG. 6C. In this way, in the present exemplary embodiment, projection image 10 is projected on a position easily seen by person 6 or easily noticed by person 6 according to the change of crowd 70, so that attention of person 6 can be attracted.

2-2. Detail of Operation

The detail of the operation of projector apparatus 100 according to the present exemplary embodiment will be described below.

2-2-1. Tracking Operation of Projection Image

Firstly, the tracking operation of a projection image of projector apparatus 100 according to the present exemplary embodiment will be described with reference to FIGS. 1 to 4, 6A, 6B, and 6C. Firstly, distance detector 230 in projector apparatus 100 detects distance information on floor surface 81 illustrated in FIG. 6A (see FIGS. 3 and 4). Controller 210 detects specific person 6 based on the detected distance information, and further detects the position and the direction of movement of person 6. Drive unit 110 drives the body of projector apparatus 100 in the pan direction or tilt direction according to a drive control of controller 210 in such a manner that projection image 10 is projected on projection position P1 which is located forward by a predetermined distance on an extension of the direction of movement of person 6 (see FIGS. 1 and 2). Controller 210 detects the position and the direction of movement of person 6 every predetermined period (for example, 1/60 second) to set projection position P1, and controls the drive of drive unit 110 to cause projection image 10 to track person 6.

2-2-2. Changing Projection Process

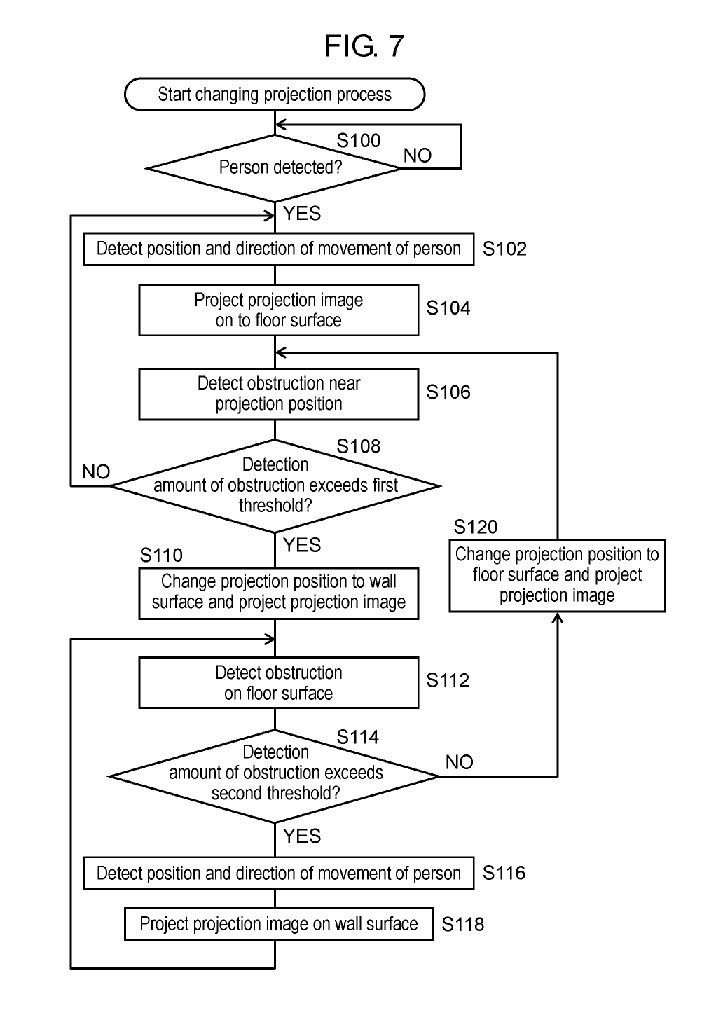

Next, the flow of the changing projection process of projector apparatus 100 according to the present exemplary embodiment will be described with reference to FIGS. 6A, 6B, 6C, and 7. The changing projection process is to change a projection position to a floor surface or a wall surface according to the detection result of an obstruction and project a projection image to the changed projection position. FIG. 7 is a flowchart illustrating the flow of the changing projection process according to the present exemplary embodiment. This flow is executed by controller 210 in projector apparatus 100 (see FIG. 3).

Firstly, controller 210 determines whether or not distance detector 230 detects specific person 6 (S100). Person 6 is an object that is tracked so that projection image 10 is projected for person 6. Person 6 is detected from distance information of floor surface 81 on which person 6 is present. The distance information is an image showing the detection result of the distance detected by distance detector 230, for example (see FIG. 4). The method for detecting person 6 will be described below.

When it is determined that person 6 is detected (YES in S100), controller 210 detects the position and the direction of movement of detected person 6 based on the distance information (S102). The detail of the method for detecting the position and the direction of movement of person 6 will also be described below.

Next, controller 210 sets projection position P1 on floor surface 81 based on the position and the direction of movement of person 6 detected in step S102, and projects projection image 10 on projection position P1 as illustrated in FIG. 6A (S104). In the process in step S104, controller 210 controls drive unit 110 to turn the projection direction of projector apparatus 100 toward projection position P1 (see FIG. 2), controls image generator 400 to generate projection image 10, and controls projection optical system 500 to align the angle of view for projecting projection image 10 to projection position P1 (see FIG. 3). Controller 210 controls image generator 400 to perform geometric correction of projection image 10 to floor surface 81, and controls projection optical system 500 to align a focal point of projection image 10 on projection position P1. Projection position P1 is set on floor surface 81 on an extension of the direction of movement of person 6 in order that person 6 easily sees projection image 10. The detail of projection position P1 will be described below.

Next, controller 210 detects obstruction 7 near projection position P1 on the extension of the direction of movement of person 6 using the distance information (S106). Obstruction 7 is detected in such a manner that a detection amount showing the congestion degree of overlapped obstructions 7 near projection position P1 is extracted from the distance information that is the detection result of distance detector 230. The congestion degree of obstructions is a number or density of the obstructions within the projection region. The detail of the method for detecting the congestion degree of obstructions 7, i.e., the method for detecting crowd 70 will be described below.

Next, controller 210 determines whether or not the detection amount of obstruction 7 with the detection process in step S106 exceeds a predetermined first threshold (S108). The first threshold is a reference threshold in determining that crowd 70 becomes the obstruction of the projecting operation due to an increase in obstructions 7. When it is determined that the detection amount of obstruction 7 does not exceed the first threshold (NO in S108), controller 210 returns to the process in step S102.

On the other hand, when it is determined that the detection amount of obstruction 7 exceeds the first threshold (YES in S108), controller 210 projects projection image 10 while changing the projection region to wall surface 82 from floor surface 81 as illustrated in FIG. 6B (S110). Specifically, controller 210 projects projection image 10 by changing projection position P1 on floor surface 81 to projection position P2 on wall surface 82. Projection position P2 is located at an eye level on wall surface 82 for easy viewing by person 6. The detail of projection position P2 will be described below.

Controller 210 now sets projection position P2 based on the detection result in step S102, and controls drive unit 110 to change the projection region to wall surface 82 from floor surface 81. In addition, controller 210 controls image generator 400 to perform geometric correction of projection image 10 relative to wall surface 82, and controls projection optical system 500 to align the focal point of projection image 10 on projection position P2. In this case, the angle of view of distance detector 230 is set wider than the angle of view for projection. Although drive unit 110 changes the projection region of projection image 10 to wall surface 82 from floor surface 81, drive unit 110 drives projector apparatus 100 such that projection position P1 on floor surface 81 is included in the detection region with distance detector 230.

Next, controller 210 detects an obstruction on floor surface 81 from the distance information on floor surface 81 (S112), as in the process in step S106.

Next, controller 210 determines whether or not the detection amount of obstruction 7 with the detection process in step S108 exceeds a predetermined second threshold (S114). The second threshold is a reference threshold in determining that crowd 70 is cleared due to a decrease in obstructions 7, and the second threshold is set smaller than the first threshold.

When it is determined that the detection amount of obstruction 7 exceeds the second threshold (YES in S114), controller 210 detects the position and the direction of movement of person 6 that is now tracked (S116).

Next, controller 210 sets projection position P2 on wall surface 82 based on the position and the direction of movement of person 6 detected in step S116, and projects projection image 10 on projection position P2 (S118).

On the other hand, when it is determined that the detection amount of obstruction 7 does not exceed the second threshold (NO in S114), controller 210 returns the projection region to floor surface 81 from wall surface 82. Specifically, controller 210 projects projection image 10 by changing projection position P2 on wall surface 82 to projection position P1 on floor surface 81 (S120) as illustrated in FIG. 6C. Controller 210 controls image generator 400 to perform geometric correction of projection image 10 to floor surface 81, and controls projection optical system 500 to align the focal point of projection image 10 on projection position P1. Controller 210 sequentially performs the processes after step S106, subsequent to the process in step S120.

As described above, projector apparatus 100 according to the present exemplary embodiment monitors the condition of crowd 70 by continuously detecting the congestion degree of obstructions 7 on floor surface 81 in steps S106 and S112. Then, when crowd 70 occurs, projector apparatus 100 changes the projection position of projection image 10 to wall surface 82 from floor surface 81 (S110). When crowd 70 is cleared away after that, projector apparatus 100 returns the projection position to floor surface 81 (S120). With this, projection image 10 is projected on a position easily seen by person 6 according to the condition of crowd 70. Notably, floor surface 81 is one example of a first projection region where projection image 10 is projected for person 6, and wall surface 82 is one example of a second projection region different from the first projection region.

Further, in the present exemplary embodiment, projection positions P1 and P2 on floor surface 81 and on wall surface 82 are changed using drive unit 110 in steps S110 and S120, and the angle of view for projection of projection image 10 is set for one of floor surface 81 and wall surface 82. If the angle of view for projection is widened to the entire region where an image may be projected, brightness or resolution is reduced. However, when the angle of view for projection is narrowed by changing the projection direction with drive unit 110 as in the present exemplary embodiment, a bright projection image having a high resolution can be projected in a wide range.

In addition, drive unit 110 causes projection image 10 to track person 6 in steps S104 and S118. With this, the angle of view for projection of projection image 10 can further be narrowed on floor surface 81 or wall surface 82, so that image quality of projection image 10 can be enhanced.

Further, in the determination process in steps S108 and S114, the second threshold for the changeover from projection position P2 to projection position P1 is set smaller than the first threshold for the changeover from projection position P1 to projection position P2, so as to form a hysteresis width. Thus, the changing operation of projection positions P1 and P2 can be stabilized.

In addition, in the processes in steps S110 and S120, image quality of projection image 10 may be changed in changing projection positions P1 and P2 of projection image 10 on floor surface 81 and wall surface 82. Specifically, memory 220 preliminarily stores an image quality data table including attribute information such as a color, diffusion reflectivity, and mirror reflectivity of each of floor surface 81 and wall surface 82. Controller 210 reads the image quality data table from memory 220. Controller 210 controls image generator 400 based on the read image quality data table to generate projection image 10 by performing chromaticity correction or brightness correction of a set value according to the attribute information of floor surface 81 and wall surface 82.

For example, in a case where wall surface 82 is red, the red content in projection image 10 is not noticeable. Therefore, controller 210 emphasizes red in projection image 10 or red color in the content of projection image 10 is replaced by black color.

Further, in a case where a projection plane on which a projection image is to be projected has a high diffusion reflectivity, projection light is diffused on the projection plane. Therefore, in a case where one of floor surface 81 and wall surface 82 has a high diffusion reflectivity even if they have similar color, controller 210 performs correction to increase brightness of projection image 10 upon projecting projection image 10 on the surface. Reflection light of projection image 10 is dazzling on a surface having a high mirror reflectivity. Therefore, controller 210 performs correction to decrease brightness of projection image 10 upon projecting projection image 10 on such a surface.

2-2-3. With Regard to Method for Detecting Person and Crowd

Next, the method for detecting a person and crowd with projector apparatus 100 according to the present exemplary embodiment will be described.

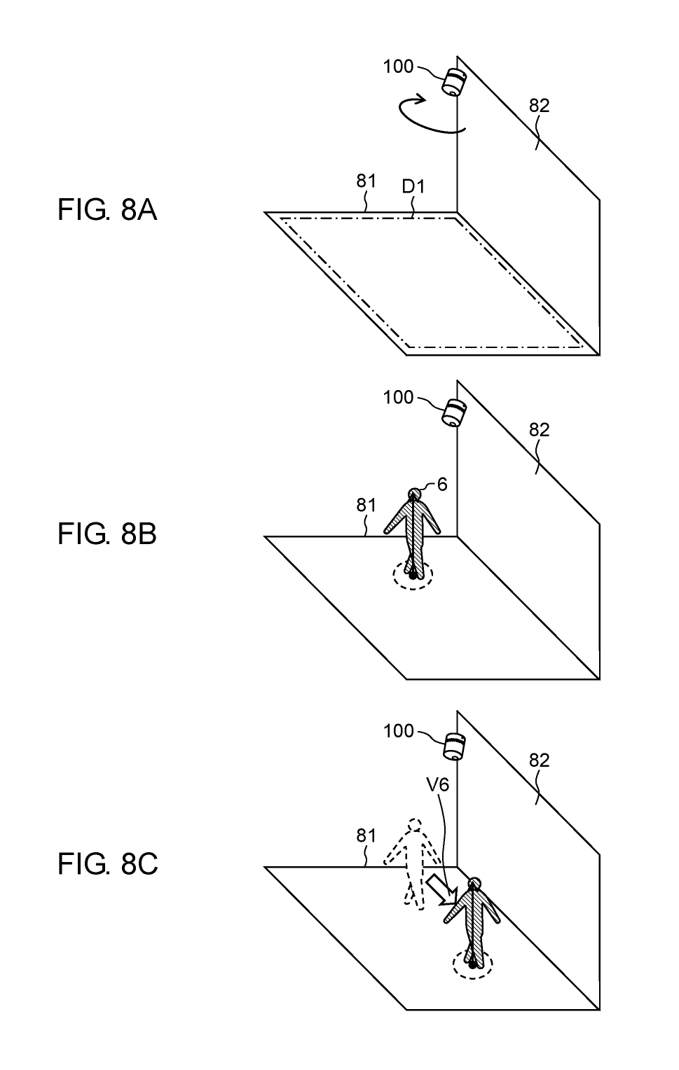

Firstly, the method for detecting a person in step S100 in FIG. 7 will be described with reference to FIGS. 8A, 8B, and 8C.

As illustrated in FIG. 8A, projector apparatus 100 preliminarily acquires basic depth information D1 indicating the distance from floor surface 81 to projector apparatus 100 with a state in which person 6 or obstruction 7 is not present on floor surface 81. The basic depth information D1 is the distance image of floor surface 81 having no obstructions, for example, and it is acquired in advance using distance detector 230 in initial setting after a power source is turned on, and stored in memory 220 (see FIG. 3).

Controller 210 in projector apparatus 100 continuously acquires distance information on floor surface 81 using distance detector 230, and analyses the change in the acquired distance information to basic depth information D1. In a case where person 6 enters on floor surface 81 within the detection region of distance detector 230 as illustrated in FIG. 8B, for example, the distance image having the amount of change according to the shape of person 6 is detected. Controller 210 detects the pixel in which the amount of change to basic depth information D1 in the distance image becomes not less than a predetermined threshold, and extracts a spatial group of such pixels. When the size occupied by the extracted groups of pixels which are spatially continuous exceeds a predetermined threshold corresponding to the size of human, controller 210 detects the presence of person 6.

When detecting the presence of person 6, controller 210 detects the position of person 6 based on the detected group of pixels in the distance information (see step S102 in FIG. 7). In this case, the position of person 6 is detected every predetermined period (for example, 1/60 second). In a case where person 6 moves as illustrated in FIG. 8C, controller 210 detects the direction of movement V6 of person 6 by analyzing a position vector of the amount of change before and after the predetermined period has elapsed. Notably, controller 210 may detect the moving speed of person 6 by analyzing the temporal change in the position vector of the amount of change.

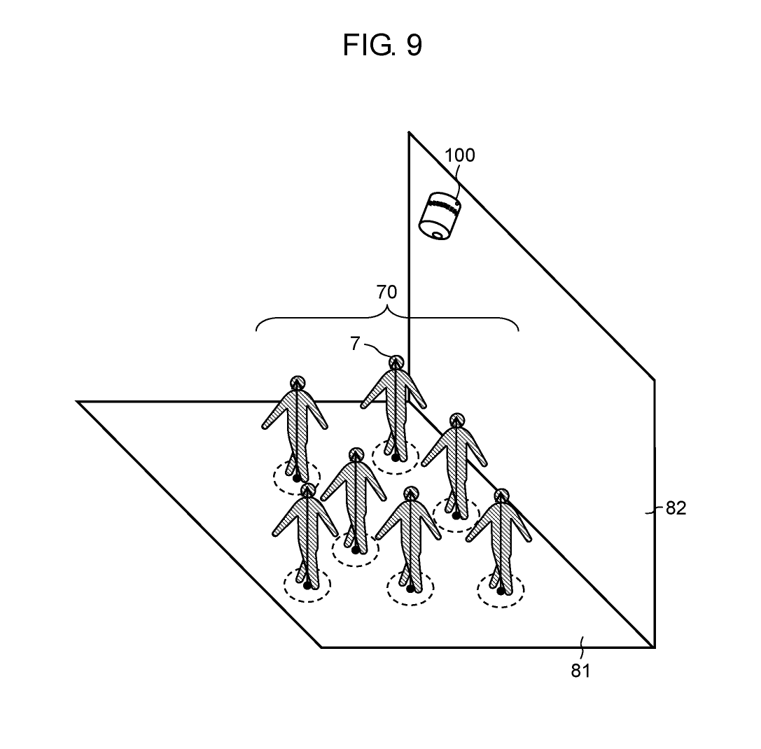

Next, the method for detecting a crowd in steps S106 and S112 in FIG. 7 will be described with reference to FIG. 9. FIG. 9 is an explanatory view for describing the method for detecting a crowd.

In the detection of crowd 70, controller 210 firstly detects the detection amount of obstructions 7 on floor surface 81. Specifically, controller 210 detects the number of obstructions 7, which are concurrently present, in the distance image detected by distance detector 230 as the detection amount. When doing so, controller 210 firstly detects the pixel in which the amount of change to basic depth information D1 in the distance image becomes not less than a predetermined threshold, and extracts a spatial group of such pixels. When the size occupied by the extracted groups of pixels which are spatially continuous exceeds a predetermined threshold corresponding to the size of human, controller 210 detects the presence of one obstruction 7. Controller 210 counts a number of groups of pixels with the size not less than the predetermined threshold to detect the number of obstructions 7.

Next, controller 210 compares the detected number of obstructions 7 to a number of first or second thresholds to determine the congestion or clearing of crowd 70. Specifically, when the number of obstructions 7 exceeds the number of first thresholds, controller 210 determines that crowd 70 on floor surface 81 corresponds to an exception condition, and exceptionally projects the projection image on wall surface 82 (see steps S108 and S110 in FIG. 7). When the number of obstructions 7 does not exceed the number of second thresholds after the projection image is projected on wall surface 82, controller 210 determines that crowd 70 on floor surface 81 does not correspond to the exception condition, and returns the projection image, which is exceptionally projected on wall surface 82, to floor surface 81 (see steps S114 and S120 in FIG. 7).

The number of obstructions 7 may be detected in a region within a predetermined range in the direction of movement of person 6, such as the region overlapped with projection position P1 or the region including projection position P1 illustrated in FIG. 6B, or may be detected in a region within a predetermined range around person 6.

In addition, crowd 70 may be detected by using the density of obstructions 7 overlapped with floor surface 81 as the detection amount. In this case, controller 210 firstly detects the pixel in which the amount of change to basic depth information D1 in a region within the predetermined range in the distance image becomes not less than a predetermined threshold, and extracts an area occupied by the detected pixels. Controller 210 detects the density of obstructions 7 in the region within the predetermined range based on the extracted area. Controller 210 compares the density of detected obstructions 7 to a predetermined density corresponding to the first or second threshold, thereby determining an exception condition as in the above case.

Alternatively, crowd 70 may be detected by extracting a region having no obstructions 7 on floor surface 81. In this case, controller 210 extracts a region not overlapped with obstructions 7 within the predetermined range on floor surface 81 based on the distance image that is the detection result of distance detector 230, and detects a display size falling within the extracted region. Controller 210 compares the detected display size to a predetermined display size corresponding to the first or second threshold, thereby determining an exception condition as in the above case. It is to be noted that, in this case, the display size corresponding to the first threshold may be set smaller than the display size corresponding to the second threshold.

2-2-4. With Regard to Projection Position of Projection Image

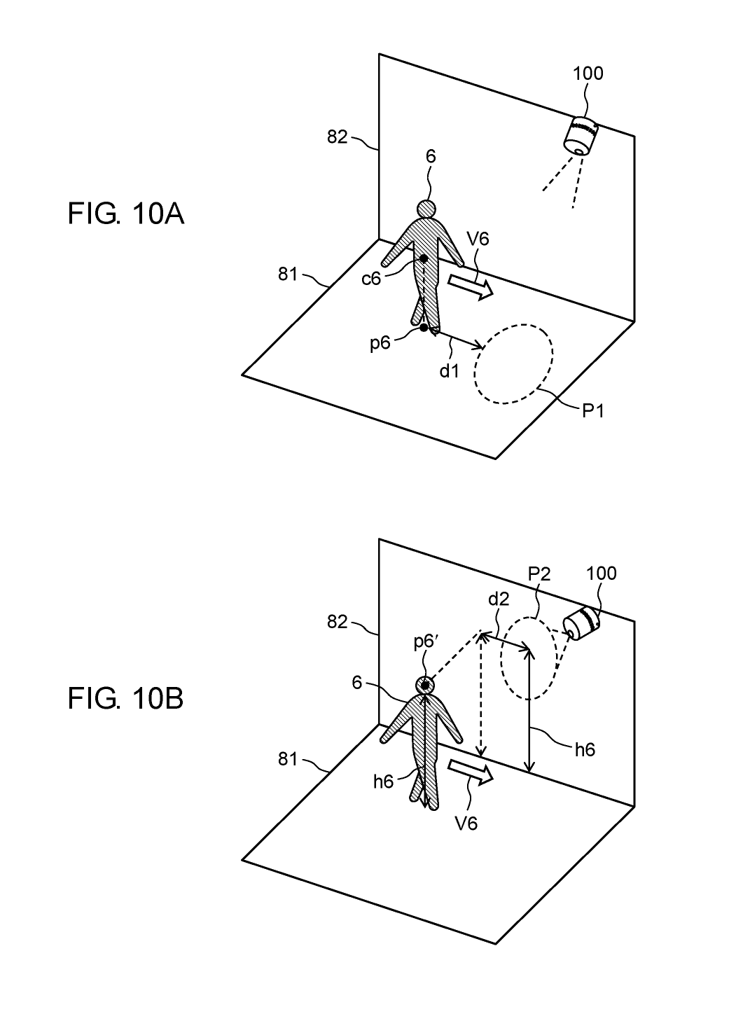

Next, a projection position of a projection image with projector apparatus 100 will be described with reference to FIGS. 10A and 10B. FIGS. 10A and 10B are explanatory views for describing a projection position of a projection image. FIG. 10A illustrates one example of a projection position on a floor surface. FIG. 10B illustrates one example of a projection position on a wall surface.

In a case where a projection image is projected on floor surface 81, projection position P1 of the projection image is set on a position ahead of position p6 of person 6 on the floor surface by predetermined distance d1 in direction of movement V6 of person 6 who is now tracked, as illustrated in FIG. 10A. Distance d1 may be a fixed value such as 1 m, or may be changed according to the moving speed of person 6. That is, the faster person 6 moves, the longer distance d1 may be set. Position p6 of person 6 on the floor surface is detected by analyzing the amount of change in the distance image in which person 6 is detected. For example, position p6 is detected as the intersection of floor surface 81 and a perpendicular drawn from position c6 of the center of gravity of person 6 to floor surface 81 as illustrated in FIG. 10A.

On the other hand, in a case where a projection image is projected on wall surface 82, projection position P2 of the projection image is set on a position with height h6 which is the same level of position p6′ of the face of person 6 on wall surface 82, the position being ahead of position p6′ of the face of person 6 by predetermined distance d2 in direction of movement V6 of person 6, as illustrated in FIG. 10B. Controller 210 extracts the height distribution of the size corresponding to the head in the distance image of person 6, thereby detecting position p6′ of the face of person 6, for example. Distance d2 may be a fixed value such as 1 m, or may be changed according to the moving speed of person 6.

Notably, if wall surface 82 is overlapped with the extension of direction of movement V6 of person 6, or wall surface 82 is overlapped with the extension at the side of direction of movement V6 of person 6, the position with height h6 on wall surface 82 on the extension in these directions may be set as projection position P2. In addition, height h6 of the face of person 6 may be calculated as the height with a predetermined ratio (for example, 80%) to the height of person 6.

Further, the projection size of the projection image may be changed according to the distance to projection position P1 from person 6. For example, in a case where an image is projected on wall surface 82 relatively far away from person 6, the image may be projected with the projection size larger than the projection size of the image which is to be projected on floor surface 81 which is relatively near person 6. With this, visibility of the projection image can be obtained, even if the image is projected at relatively a distant position from person 6.

<3. Effects>

As described above, in the present exemplary embodiment, projector apparatus 100 includes projection unit 250, distance detector 230, and controller 210. Projection unit 250 projects projection image 10. Distance detector 230 detects a state of obstruction 7 on floor surface 81 in projecting projection image 10. Controller 210 sets a region where projection image 10 is projected first to floor surface 81. Controller 210 changes the region where projection image 10 is to be projected from floor surface 81 to wall surface 82 different from floor surface 81 based on the state of obstruction 7 detected by distance detector 230, when the state of obstruction 7 corresponds to a predetermined condition. Controller 210 returns the region where projection image 10 is projected to floor surface 81 from wall surface 82, when the predetermined condition for the state of obstruction 7 is resolved.

According to projector apparatus 100 according to the present exemplary embodiment, a projection image is basically projected on floor surface 81, and when the state of obstruction 7 corresponds to the predetermined condition, the projection region is changed to wall surface 82 from floor surface 81. When the state of obstruction 7 no longer corresponds to the predetermined condition after that, projector apparatus 100 returns projection image 10 to floor surface 81. With this, projection image 10 can be projected at a position where person 6 easily sees projection image 10, when projection image 10 is projected for presentation to person 6.

In addition, in the present exemplary embodiment, distance detector 230 detects specific person 6. Then, controller 210 causes projection image 10 projected with projection unit 250 to track person 6 detected by distance detector 230. Therefore, when person 6 moves, the projection image is projected while tracking person 6, so that visibility of the projection image for specific person 6 can be enhanced.

### Other Exemplary Embodiments

As described above, the first exemplary embodiment has been described as an illustration of the technology disclosed in the present application. However, the technology in the present disclosure is not limited to this, and can be applied to exemplary embodiments in which various changes, replacements, additions, omissions, etc., are made. Furthermore, an exemplary embodiment can be formed by combining each component described in the first exemplary embodiment.

The other exemplary embodiments will be described below.

Projector apparatus 100 according to the first exemplary embodiment includes distance detector 230 as one example of the second detector that detects a person. However, the second detector is not limited thereto. For example, instead of or in addition to distance detector 230, an imaging unit that captures an image with visible light (RGB) may be provided. For example, controller 210 may recognize a person or an obstruction with an image analysis performed to the image captured by an imaging unit.

For example, projector apparatus 100 may include an imaging unit configured by a CCD camera or the like. The direction of movement or orientation of a person or the congestion degree of obstruction may be extracted from the image captured by the imaging unit. For example, controller 210 may recognize the eye level of person 6, who is now tracked, with an image analysis to the RGB image, and set projection position P2 on wall surface 82 illustrated in FIG. 8B on the extension of the eye level of person 6.

Further, projector apparatus 100 according to the first exemplary embodiment includes distance detector 230 as one example of the first detector that detects the state of an obstruction. However, the first detector is not limited thereto. For example, in detecting crowd 70 illustrated in FIG. 9, an area occupied by colors different from the color of floor surface 81 may be detected in the RGB image of floor surface 81 using an imaging unit. In this case, controller 210 performs the determination processes in steps S108 and S114 in FIG. 7 by using the area detected with use of the imaging unit as the detection amount of obstruction 7.

Projector apparatus 100 according to the first exemplary embodiment includes distance detector 230 as one example of the first and second detectors. That is, the first exemplary embodiment describes that the first and second detectors are configured by one sensor. However, the configuration is not limited thereto. The first detector and the second detector may be configured by different sensors. For example, one of distance detector 230 and the imaging unit may be specified as one of the first and second detectors, or distance detector 230 and the imaging unit both function as the first and second detectors. In addition, distance detector 230 is fixed such that the projection direction and orientation thereof are aligned to those of projection unit 250. However, the configuration is not limited thereto. For example, distance detector 230 may be provided at a position different from the installation position of projector apparatus 100.

In the first exemplary embodiment, the projection position of a projection image is changed so as to track a person with drive unit 110. However, the configuration is not limited thereto. For example, the angle of view for projection may be set wider than the projection image actually projected, and the projection image may be moved within the range of the angle of view for projection. In this case, the projection on a floor surface and the projection on a wall surface may be changed within the same angle of view for projection, for example.

In the first exemplary embodiment, an object to which a projection image is presented from projector apparatus 100 is specific person 6. However, the exemplary embodiment is not limited thereto. The object to which the projection image is presented may be a group of persons or a vehicle such as an automobile. In addition, an obstruction is not limited to a person, but may be a vehicle such as an automobile.

In addition, a projection image projected for presentation to an object may be a still image or a moving image. In a case where the projection apparatus projects a projection image while tracking an object, the projection apparatus may move and project the projection image to lead the object. The content of the projection image is not necessarily the one leading person 6. It may be the one performing advertisement, for example. In addition, the projection apparatus does not necessarily project a projection image while tracking an object. For example, the projection apparatus may project a projection image to a group of persons such that each person can easily see the projection image.

In the first exemplary embodiment, floor surface 81 is specified as the first projection region, and wall surface 82 is specified as the second projection region, for example. However, the first and second projection regions are not limited thereto. For example, a wall surface may be specified as the first projection region, and a floor surface may be specified as the second projection region. Further, a ceiling surface of a building may be specified as the first or second projection region, for example. For example, projector apparatus 100 may be installed on staircases, a wall surface may be specified as the first projection region, and a ceiling surface may be specified as the second projection region, then a projection image may basically be projected on the wall surface, and may exceptionally be projected on the ceiling surface.

The projection apparatus according to the present disclosure is applicable to a variety of uses for projecting a video image onto a projection plane.

What is claimed is:

1. A projection apparatus comprising:
a projection unit configured to project a projection image;
a first detector configured to detect, within a predetermined first projection region, a congestion degree of obstructions overlapped with the first projection region in projecting the projection image; and
a controller configured to set a region where the projection image is projected first to the first projection region, and when the congestion degree of the obstructions detected by the first detector exceeds a predetermined first threshold, change the region where the projection image is projected to a predetermined second projection region different from the first projection region.

2. The projection apparatus according to claim 1, wherein the controller returns the region where the projection image is projected to the first projection region from the second projection region, when the congestion degree of the obstructions does not exceed a predetermined second threshold equal to or lower than the first threshold.

3. The projection apparatus according to claim 1, wherein the congestion degree of the obstructions is a number or density of the obstructions within the first projection region.

4. The projection apparatus according to claim 1, further comprising a second detector configured to detect a specific object, wherein
the controller causes a projection image projected by the projection unit to track an object detected by the second detector.

5. The projection apparatus according to claim 4, wherein
the controller detects a position and a direction of movement of the object based on a detection result of the second detector, and causes the projection image to track the direction of movement of the object within the first projection region or the second projection region.

6. The projection apparatus according to claim 4, wherein
at least one of the first detector and the second detector includes a distance detector that detects a distance from the object and the obstruction to the projection apparatus.

7. The projection apparatus according to claim 4, wherein
at least one of the first detector and the second detector includes an imaging unit that captures a captured image of the object and the obstruction.

8. The projection apparatus according to claim 4, further comprising a drive unit configured to drive the projection unit so as to change a projection direction in which the projection image is to be projected, wherein
the controller controls the drive unit such that the projection image tracks the object.

9. The projection apparatus according to claim 1, wherein the first projection region is a region on a floor, and the second projection region is a region on a wall substantially orthogonal to the floor.
